(19) United States
(12) Patent Application Publication
(10) Pub. No.: US 2026/0290161 A1
(43) Pub. Date: Sep. 24, 2026

(54) VEHICLE CONTROL SYSTEM

(71) Applicant: HONDA MOTOR CO., LTD., Tokyo (JP)

(72) Inventors: Hiromu AOKI, Tokyo (JP); Nobuharu NAGAOKA, Tokyo (JP); Shun MORISHITA, Tokyo (JP)

(21) Appl. No.: 19/575,270

(22) Filed: Mar. 23, 2026

(30) Foreign Application Priority Data
Mar. 24, 2025 (JP) 2025-049044

(51) Int. Cl. G08G 1/0967; G08G 1/052

(52) U.S. Cl. CPC G08G 1/0967; G08G 1/052

(57) ABSTRACT

A vehicle control system comprises an alert controller for alerting a driver of a vehicle. The alert controller estimates, at predetermined intervals, a visibility distance W at which the driver can visually recognize an object, and calculates an object distance X between the vehicle and the object ahead in a traveling direction of the vehicle. The alert controller can perform controls so as to provide a first-type alert when the object distance X is less than or equal to a sensing distance S (X≤S) and less than the visibility distance W (X<W), and provide a second-type alert that is more emphasized than the first-type alert when the object distance X is less than or equal to the sensing distance S (X≤S) and greater than or equal to the visibility distance W (W≤X).

### TECHNICAL FIELD

The present invention relates to a vehicle control system.

### BACKGROUND ART

In recent years, active efforts have been made aimed at providing sustainable transportation systems that take into consideration vulnerable persons among traffic participants. To achieve this aim, research and development on autonomous driving technology and driver assistance systems are underway in order to further improve traffic safety and convenience.

One example of such technology aims to alert a driver of a vehicle to objects near the vehicle, thereby providing driving assistance. For example, Patent Document 1 discloses a control device that vibrates a steering wheel of a vehicle when another vehicle is traveling ahead thereof. The control device in Patent Document 1 changes the intensity of the vibration of the steering wheel according to the distance between the user vehicle and another vehicle. A driver of the vehicle can recognize the distance based on the intensity of the vibration of the steering wheel.

### Prior Art Documents

### Patent Documents

Patent Document 1: WO2020/235305A1

### SUMMARY OF THE INVENTION

### Task to be Accomplished by the Invention

Usually, drivers recognize the presence of objects such as other vehicles or fallen objects by visually confirming their positions. In the case of a driver of a vehicle equipped with the control device of Patent Document 1 first recognizes the presence of another vehicle through steering wheel vibration, then visually confirms the other vehicle to determine its position. However, a driver's visibility distance can be shortened by fatigue. Thus, in the case where the driver's visibility distance shortens due to fatigue, even when the driver of a vehicle equipped with the control device in Patent Document 1 recognizes the presence of another vehicle through steering wheel vibration, the shortened visibility distance may make it difficult for the driver to visually confirm the position of the other vehicle. Thus, there is a need for technology that can properly alert a driver whose visibility distance is reduced due to fatigue or other reasons that an object is approaching a vehicle.

The present invention has been made in view of the problem of the prior art, and one object of the present invention is to provide a vehicle control system for alerting a driver whose visibility distance is reduced compared to normal conditions, that an object is approaching a vehicle, which can properly alert the driver that an object is approaching a vehicle, thereby promoting further development of sustainable transportation systems.

### Means to Accomplish the Task

As a solution to the above-described task to be accomplished, an aspect of the present invention provides a vehicle control system comprising: a surrounding information acquirer for detecting information on an object near a vehicle; a notifier for alerting a driver in the vehicle; and an alert controller for controlling the notifier such that the notifier alerts the driver based on a detection result from the surrounding information acquirer, wherein the surrounding information acquirer detects information on an object ahead at a distance that is less than or equal to a sensing distance in a traveling direction of the vehicle, wherein the alert controller is configured to: estimate, at predetermined intervals, a visibility distance at which the driver of the vehicle can visually recognize the object; and calculate an object distance between the object and the vehicle based on the detection result from the surrounding information acquirer, wherein, when the object distance is less than or equal to the sensing distance and less than the visibility distance, the alert controller causes the notifier to provide a first-type alert, and wherein, when the object distance is less than or equal to the sensing distance and greater than or equal to the visibility distance, the alert controller causes the notifier to provide a second-type alert that is more emphasized than the first-type alert.

### Effect of the Invention

The above-described embodiment of the present invention is to provide a vehicle control system which can properly alert a driver whose visibility distance is reduced compared to normal conditions, to the approach of an object to a vehicle.

### BRIEF DESCRIPTION OF THE DRAWINGS

FIG. 1 is a block diagram showing a general configuration of a vehicle provided with a vehicle control system according to an embodiment of the present invention;

FIG. 2 is a diagram showing a state record table;

FIG. 3 is a diagram showing alerts provided by an alert controller when a vehicle approaches another vehicle traveling ahead of the vehicle;

FIG. 4 is a flowchart of a state recognition operation;

FIG. 5 is a flowchart of an alert operation;

FIG. 6 is a diagram showing that the alert controller provides the second-type alert when an object distance is greater than or equal to the visibility distance and less than or equal to a sensing distance and the alert controller has not provided a second-type alert so far since the detection of an object;

FIG. 7 is a diagram showing that the object distance is less than the visibility distance and the alert controller is providing a first-type alert;

FIG. 8 is a diagram showing that the alert controller provides the first-type alert when the object distance is presently greater than or equal to the visibility distance and has been less than the visibility distance within a predetermined time period from the present; and

FIG. 9 is a diagram showing that, when a time has elapsed while the object distance is greater than or equal to the visibility distance, the alert controller provides the first-type alert; and the second-type alert.

### DESCRIPTION OF THE PREFERRED EMBODIMENTS

Embodiments of a vehicle control system 1 of the present invention will be described with reference to the appended drawings. In the drawings and the following description, direction-indicating terms such as front, rear, left and right refer to their corresponding directions of a vehicle 3 provided with the vehicle control system 1. The user vehicle 3 provided with the vehicle control system 1 is also referred to as "user vehicle 3."

### Vehicle 3

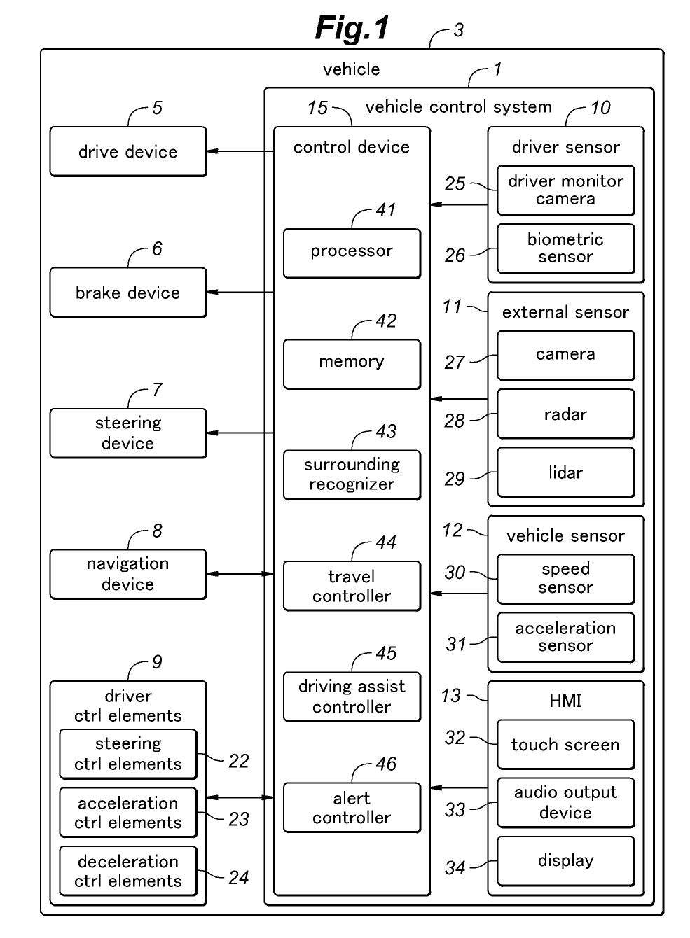

FIG. 1 is a block diagram showing a general configuration of a vehicle 3 provided with a vehicle control system 1. For example, the user vehicle 3 is an automobile. In other embodiments, the user vehicle 3 may be a vehicle other than an automobile (e.g., a two-wheeled vehicle).

As shown in FIG. 1, the user vehicle 3 includes a drive device 5, a brake device 6, a steering device 7, a navigation device 8, driver control elements 9, a driver sensor 10, an external sensor 11, a vehicle sensor 12, an HMI 13 (Human Machine Interface), and a control device 15. The driver sensor 10 is an example of a driver information acquirer that detects information on a driver's condition. The external sensor 11 is an example of a surrounding information acquirer that detects the positions of objects present around or near the user vehicle 3. The HMI 13 is an example of a notifier that alerts a driver of the user vehicle 3. The vehicle control system 1 of the present embodiment comprises the driver information acquirer (driver sensor 10), the surrounding information acquirer (external sensor 11), the vehicle sensor 12, a notifier (HMI 13), and the control device 15.

The drive device 5 is a device that provides driving force to the user vehicle 3. The drive device 5 includes a drive source that generates driving force to propel the user vehicle 3. For example, the drive source is configured by an internal combustion engine and/or an electric motor.

The brake device 6 is a device that provides braking force to the user vehicle 3. For example, the brake device 6 includes brake calipers that press pads against brake rotors, and electric cylinders that supply hydraulic pressure to the brake calipers.

The steering device 7 is a device that turns the wheels to change the steering angle thereof. For example, the steering device 7 includes a rack-and-pinion mechanism connected to the wheels and an electric motor that drives the rack-and-pinion mechanism.

The navigation device 8 is a device that provides routing information regarding travel to a destination for the user vehicle 3. The navigation device 8 stores map information. The navigation device 8 determines the current position of the user vehicle 3 based on GNSS signals (e.g., GPS signals) received from satellites. The navigation device 8 generates a route plan for the user vehicle 3. The navigation device 8 can display the current position of the user vehicle 3, the route plan, and a map of an area at and around the user vehicle 3 on a touch screen 32 described later.

The driver control elements 9 are devices that receive driving operations performed by a driver in the user vehicle 3 (hereinafter referred to simply as "driver"). The driver control elements 9 include: a steering control element 22 (e.g., steering wheel) that receives steering operations performed by the driver in the user vehicle 3; an acceleration control element 23 (e.g., accelerator pedal) that receives acceleration operations performed by the driver in the user vehicle 3; and a deceleration control element 24 (e.g., brake pedal) that receive deceleration operations performed by the driver in the user vehicle 3.

The driver sensor 10 is a device that detects a driver's condition. The driver sensor 10 includes a driver monitor camera 25 and a biometric sensor 26. The driver monitor camera 25 captures images of a driver.

The biometric sensor 26 may include an electrostatic sensor mounted on a steering control element 22 to detect the position where a driver contacts the element. The biometric sensor 26 may also be a heart rate sensor, respiration sensor, pressure sensor, and/or electroencephalogram (EEG) sensor installed in the driver's seat. The heart rate sensor is a sensor positioned to correspond to the driver's heart to detect the driver's heart rate. The heart rate sensor may be any type of heart rate sensor, such as a touch-type, optical-type, or electrocardiogram-type heart rate sensor. The respiration sensor is a sensor positioned to correspond to the driver's lungs to detect the driver's respiration rate and depth of breathing. The respiration sensor may include a pressure sensor that detects pressure applied by the driver, and may be configured to detect respiration rate and depth based on changes in pressure applied to the pressure sensor that occur due to the driver's respiratory movements. The EEG sensor is positioned to face the driver's head and includes a magnetic sensor that detects magnetic signals associated with the driver's brain cell activity, the EEG sensor being configured to calculate the driver's brainwaves based on the magnetic signals detected by the magnetic sensor. Furthermore, the biometric sensor 26 may be a blood pressure sensor. The biometric sensor 26 is not limited to these sensors; it may be any sensor that detects biometric information (such as the driver's blood flow).

The external sensor 11 is a device that acquires information about the surroundings of the user vehicle 3. The external sensor 11 includes a plurality of cameras 27, a plurality of radars 28, and a plurality of lidars 29 (LiDARs). Each of the cameras 27 captures images containing objects present near the user vehicle 3 such as nearby vehicles (including a vehicle ahead), motorcycles, and pedestrians, and road components indicating the road's shape such as lane markings. Each of the radars 28 emits radio waves, such as millimeter electromagnetic waves, to the surroundings of the user vehicle 3 and detects the positions of objects present near the user vehicle 3 by acquiring the reflected electromagnetic waves. Each of the lidars 29 irradiates the surroundings of the user vehicle 3 with light, such as infrared light, and detects the positions of objects present near the user vehicle 3 by acquiring the reflected light.

The vehicle sensor 12 shown in FIG. 1 is a sensor device that detects the traveling state of the user vehicle 3. The vehicle sensor 12 includes a speed sensor 30 that detects the speed of the user vehicle 3, and an acceleration sensor 31 that detects the acceleration and deceleration of vehicle 3.

The HMI 13 is a device that alerts a driver and receives the driver's input operations. The HMI 13 includes the touch screen 32, an audio output device 33, and a display 34 (display device, not shown). The touch screen 32 displays various screens to the driver and receives the occupant's input operations on these screens. The audio output device 33 outputs audio assist information, warning sounds, and similar audio information. The display 34 may indicate vehicle speed, tachometer readings, and driving assist information.

### Control Device 15

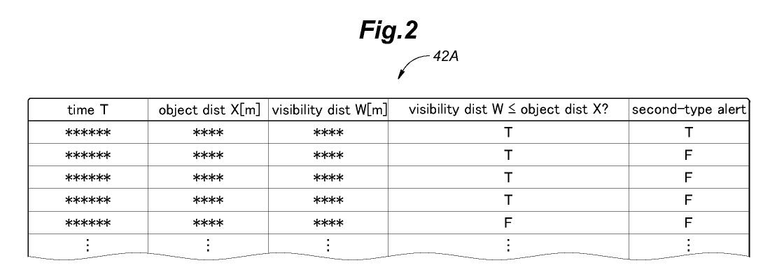

The control device 15 is a computer including a processor 41 and a memory 42 communicatively connected to the processor 41. The processor 41 may include, for example, at least one of a CPU, GPU, or MPU as a core element. The memory 42 stores programs that are executable by the processor 41 and various data. The memory 42 stores data including a state record table 42A (FIG. 2). The memory 42 may include at least one of volatile memory and non-volatile memory. The volatile memory may be, for example, DRAM or SRAM. The non-volatile memory may be an SSD, flash memory, magnetic disk storage device, or optical disk storage device. At least part of the control device 15 may be implemented by hardware such as LSI, ASIC, or FPGA, or by a combination of software and hardware. The control device 15 may be configured by a single piece of hardware or by a plurality of pieces of hardware capable of communicating with each other.

FIG. 2 is a diagram showing a state record table 42A. As shown in FIG. 2, the state record table 42A stores sets of associated records of Time T, Object distance X, which is a distance between a user vehicle 3 and an object ahead of the user vehicle 3, estimated Visibility Distance W of a driver, a truth-value indicating whether the object distance X is less than or equal to the visibility distance W ("T" if the visibility distance W ≤ the object distance X, "F" if the visibility distance W > the object distance X), Information indicating if the second-type alert has been provided ("T" or "F").

The control device 15 includes a surrounding recognizer 43, a travel controller 44, a driving assist controller 45, and an alert controller 46 as functional units. The processor 41 implements the surrounding recognizer 43, travel controller 44, driving assist controller 45, and alert controller 46 by executing programs stored in the memory 42.

The surrounding recognizer 43 recognizes a situation of the surroundings of the user vehicle 3 based on information acquired by the external sensor 11. For example, the surrounding recognizer 43 detects the positions of objects (such as other vehicles, pedestrians, and fallen objects) present in front of the user vehicle 3 based on detection results provided from the external sensor 11. Furthermore, the surrounding recognizer 43 detects the shape of a road surrounding the user vehicle 3 based on detection results provided from the external sensor 11.

The travel controller 44 controls the traveling of the user vehicle 3 in response to the driver's driving operations on the driver control elements 9. For example, the travel controller 44 controls the steering device 7 in response to the driver's steering operations on the steering control element 22 for steering the user vehicle 3, causing the user vehicle 3 to turn. The travel controller 44 controls the drive device 5 in response to the driver's accelerating operations on the acceleration control element 23 for accelerating the user vehicle 3, causing the user vehicle 3 to accelerate. The travel controller 44 controls the brake device 6 in response to the driver's decelerating operations on the deceleration control element 24 for decelerating the user vehicle 3, causing the user vehicle 3 to decelerate. Furthermore, when controlling the steering device 7 to turn the user vehicle 3, the travel controller 44 performs turn signal controls, such as activating the turn signals.

The driving assist controller 45 performs advanced driver assistance controls, i.e., controls on advanced driver assistance systems (ADAS) for the user vehicle 3 based on recognition results from the external sensor 11. The advanced driver assistance controls correspond to SAE levels 1 to 2 of driving automation. While the advanced driver assistance controls are performed, a driver remains the primary operator of the vehicle 3 and has driving authority of the vehicle 3.

The vehicle control system 1 calculates a distance between a user vehicle 3 and an object ahead of the user vehicle 3 (referred to as "object distance X") based on the position of the object ahead of the user vehicle 3 detected by the surrounding recognizer 43, and performs a state recognition operation to estimate the visibility distance W of a driver. The alert controller 46 performs an alert operation to alert the driver based on the object distance X and the visibility distance W detected and estimated in the state recognition operation.

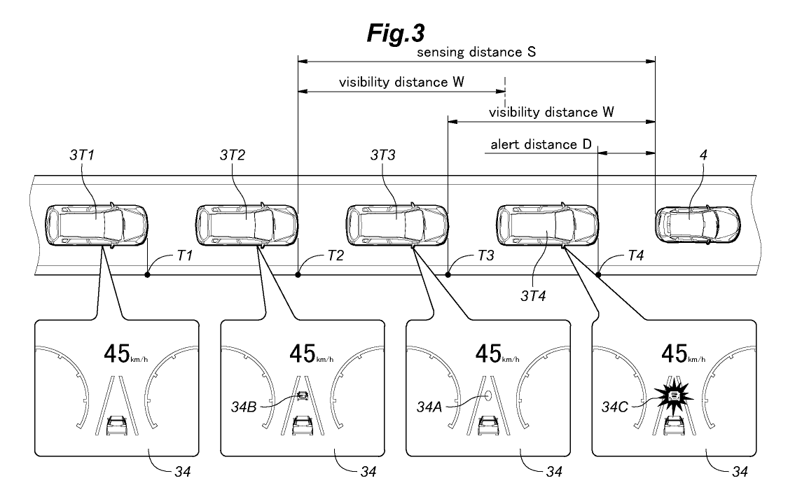

FIG. 3 is a diagram showing alerts provided by the alert controller 46 when the user vehicle 3 approaches another vehicle 4 traveling ahead of the vehicle 3. In FIG. 3, the user vehicle 3 approaches the other vehicle 4 from time T1 to time T4. In FIG. 3, the user vehicle 3 at times T1 to T4 are designated as 3T1 to 3T4. In FIG. 3, the object distance X is the distance between the other vehicle 4 and the user vehicle 3.

As described below, FIG. 3 shows a scenario where, from time T1 to time T4, the visibility distance W becomes shorter than a sensing distance S (visibility distance W < sensing distance S) due to fatigue of a driver or other reasons. The sensing distance S is the maximum distance between the user vehicle 3 and an object ahead of the vehicle 3 that requires an alert to be provided to the driver. The surrounding information acquirer (external sensor 11) cannot detect an object within a predetermined lower limit distance (e.g., 1 cm) ahead of the user vehicle 3. The alert controller 46 can provide an alert when the object distance X is greater than or equal to the lower limit distance and less than or equal to the sensing distance S. The sensing distance S may also be an upper limit value of the object distance X for an object ahead of the user vehicle 3 which the surrounding information acquirer (external sensor 11) can detect. The sensing distance S may be changed according to the speed of the user vehicle 3.

At time T1, since the object distance X between the user vehicle 3T1 and the object is sufficiently large, the alert controller 46 does not alert the driver to another vehicle 4, and a corresponding screen displayed on the display 34 does not show an icon representing the other vehicle 4.

At time T2, the object distance X between the user vehicle 3T2 and the other object is equal to the sensing distance S (the object distance X = the sensing distance S), and the object distance X is greater than the visibility distance W (visibility distance W < object distance X). The alert controller 46 provides an alert when the object distance X is less than or equal to the sensing distance S and greater than the lower limit distance.

At time T2, as the object distance X equals the sensing distance S (object distance X = sensing distance S), the driver needs to pay attention to the object. At time T2, since the object distance X is greater than the visibility distance W (visibility distance W < object distance X), the driver may not be aware of the other vehicle 4. Thus, the alert controller 46 displays the second-type alert on the display 34 throughout an alert time period Tw. Subsequently, at time T3, for the user vehicle 3T3, the alert controller 46 has ended the second-type alert and is providing a first-type alert displayed on the display 34. As the first-type alert, the alert controller 46 displays an icon 34A representing the other vehicle 4 in a simplified style, on the display 34. As the second-type alert, the alert controller 46 displays an icon 34B representing the other vehicle 4, on the display 34.

At time T3, since the object distance X is less than or equal to the visibility distance W (object distance X ≤ visibility distance W), the driver usually visually recognizes the other vehicle 4. Thus, the alert controller 46 provides the first-type alert instead of the second-type alert and continues to provide it.

At time T4, the object distance X is less than or equal to an alert distance D (e.g., 10 m). The alert distance D is shorter than the sensing distance S (alert distance D < sensing distance S). The alert controller 46 displays a third-type alert on the display 34 when the object distance X becomes less than or equal to the alert distance D. As the third-type alert, the alert controller 46 displays an icon 34C representing the other vehicle 4 on the display 34.

The second-type and third-type alerts are emphasized compared to the first-type alert. The emphasis means a higher degree of intensity in attracting a person's attention. The third-type alert may be more emphasized than the second-type alert. Alternatively, the third-type alert may be the same as the second-type alert. The degree of emphasis for the second-type alert may differ from that for the third-type alert.

As shown in FIG. 3, when the alert controller 46 provides an alert by showing icons 34A to 34C representing the other vehicle 4 (object) on the display 34, the alert may be emphasized by at least one of the following operations: increasing the size of an icon, increasing the brightness thereof, shortening the period of brightness change or flashing, or shifting the icon color tone from a cool color to a warm color.

The alert controller 46 may provide the first-type, second-type, and third-type alerts in audio forms. In this case, the alert controller 46 may emphasize an alert by at least one of the following operations: increasing the intensity of a sound generated from the audio output device 33; increasing the frequency of the sound; repeatedly generating the sound with a short repetition cycle; or shortening the cycle of changes in the sound intensity or frequency.

In other cases, the alert controller 46 may generate vibrations in the steering control element 22 to provide the first-type, second-type and third-type alerts. In this case, the alert controller 46 may emphasize an alert by at least one of the following operations: increasing the vibration intensity, increasing the vibration frequency, repeatedly generating vibrations with a shorter repetition period, or shortening the cycle period for changes in vibration intensity or frequency.

### Operations of Alert Controller 46

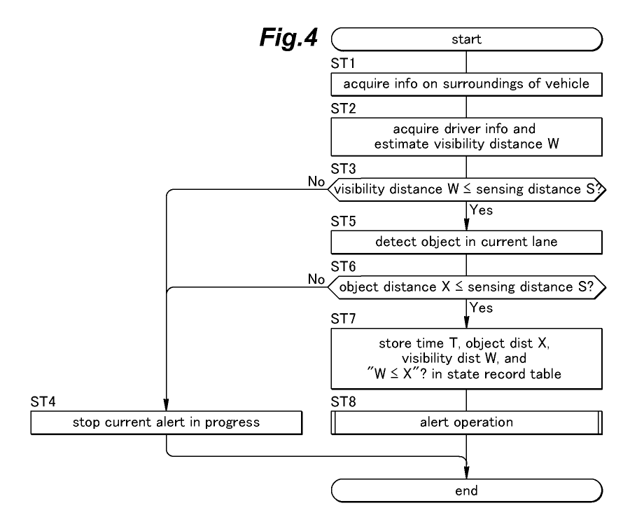

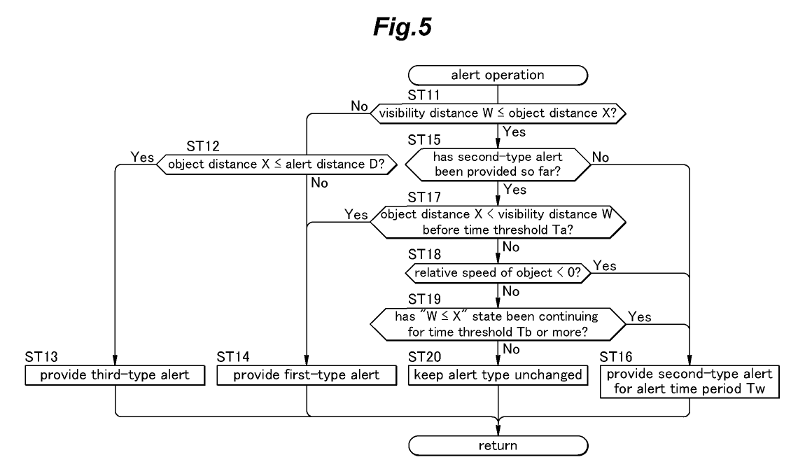

Next, referring to FIGS. 4 to 8, a state recognition operation (FIG. 4) and an alert operation (FIG. 5) that are performed by the vehicle control system 1 will be described.

### State Recognition Operation

FIG. 4 is a flowchart of the state recognition operation. When the main power of the user vehicle 3 is turned ON, the vehicle control system 1 performs the state recognition operation at predetermined time intervals. Each of the intervals at which the state recognition operation is performed may be a time interval (e.g., 10 ms) or an interval based on the distance which the user vehicle 3 travels (e.g., every 1 m of the traveling of the user vehicle 3).

In the state recognition operation, first, the external sensor 11 acquires information about the surroundings of the user vehicle 3 (user vehicle's surrounding information) (Step ST1). Next, the driver sensor 10 detects information on conditions of a driver (driver's condition information), and the alert controller 46 estimates the driver's visibility distance W based on the driver's condition information detected by the driver sensor 10 (Step ST2).

In Step ST2, the alert controller 46 may estimate the direction of the driver's line of sight based on the driver's image captured by the driver sensor 10, and estimate the visibility distance W based on the estimated direction of the line of sight. For example, the alert controller 46 may estimate the time per unit time (e.g., one minute) during which the driver's gaze is directed toward the distant front of the user vehicle 3. The visibility distance W may be estimated such that the shorter the estimated time per unit time, the shorter the visibility distance W becomes. Furthermore, the alert controller 46 may use a heart rate sensor as the driver sensor 10 and estimate the visibility distance W such that the visibility distance W becomes shorter as the driver's heart rate decreases. In some cases, the alert controller 46 may use a respiration sensor as the driver sensor 10 and estimate the visibility distance W such that the visibility distance W becomes shorter as the driver's respiration rate decreases or as the driver's respiration becomes shallower. In other cases, the alert controller 46 may use an electroencephalogram (EEG) sensor as the driver sensor 10 and estimate the visibility distance W such that the visibility distance W increases as the activity of the driver's brain cells increases.

In Step ST2, the alert controller 46 may estimate the visibility distance W of the driver driving the user vehicle 3 based on at least one of a continuous driving time of the driver, an amount of the driver's vehicle control, a driving assistance time during which the driving assist controller 45 provides a driving assistance to the driver, and an amount of the vehicle control by the driving assist controller 45. The alert controller 46 may estimate the visibility distance W such that the visibility distance W becomes shorter as the continuous driving time of the driver increases, as the amount of the driver's vehicle control increases, as the driving assistance time, during which the driving assist controller 45 provides a driving assistance to the driver, increases, or as the amount of the vehicle control by the driving assist controller 45 increases.

Next, the alert controller 46 determines whether the visibility distance W estimated in Step ST2 is less than or equal to a sensing distance S (visibility distance W ≤ sensing distance S) (Step ST3). When the alert controller 46 determines that the visibility distance W is greater than the sensing distance S (sensing distance S < visibility distance W) (No in Step ST3), the driver usually can visually recognize an object located farther than the sensing distance S from the user vehicle 3 (sensing distance S < object distance X). Thus, the alert controller 46 stops providing the current alert (Step ST4) and ends the state recognition operation. In some cases, when the alert controller 46 is providing the second-type alert or third-type alert, instead of stop providing the current alert in Step ST4, the alert controller 46 may switch the type of alert to the first-type alert to provide the first-type alert.

As described above with reference to FIG. 3, the alert controller 46 can display the first-type, second-type, or third-type alert on the display 34. When displaying an alert on the display 34, the alert controller 46 stops providing the alert in Step ST4. When not displaying an alert, the alert controller 46 does not perform any operation in Step ST4.

When, in Step ST3, the alert controller 46 determines that the visibility distance W is less than or equal to the sensing distance S (visibility distance W ≤ sensing distance S) (Yes in Step ST3), the alert controller 46 detects an object present in the current lane ahead of the user vehicle 3 based on the user vehicle's surrounding information (information about the surroundings of the user vehicle 3) acquired in Step ST1, and calculates the object distance X (Step ST5). When the visibility distance W is less than or equal to the sensing distance S (visibility distance W ≤ sensing distance S), the driver may be unable to visually recognize an object that is desirably seen. Thus, in order to alert the driver to the object, the alert controller 46 detects the object and calculates the object distance X in Step ST5. When no object is present in the current lane, there is no need to alert the driver to any object, and thus the alert controller 46 does not calculate the object distance X in Step ST5.

When the vehicle 3 plans to change its path, (e.g., change lanes), the alert controller 46 detects an objects in a target lane toward which the vehicle 3 intends to change its path, based on a detection result (user vehicle's surrounding information) from the external sensor 11 (surrounding information acquirer) in Step ST5, and then calculates a distance between the detected object and the vehicle 3 as an object distance X. Furthermore, the alert controller 46 can detect the planned change in the path of the vehicle and the target lane to which the vehicle intends to travel, based on controls of the steering device 7 performed by the travel controller 44, the route plan generated by the navigation device 8, and the operation of the occupant's turn signal (not shown).

Next, the alert controller 46 determines whether the object distance X calculated in Step ST5 is less than or equal to the sensing distance S (object distance X ≤ sensing distance S) (Step ST6). When the object is not detected in Step ST5, the alert controller 46 determines that the object distance X is greater than the sensing distance S (sensing distance S < object distance X) (No in Step ST6). When the alert controller 46 determines that the object distance X is greater than the sensing distance S (sensing distance S < object distance X) (No in Step ST6), the object distance X is sufficiently large and thus there is no need to alert the driver to the object. Thus, the alert controller 46 stops providing the alert (Step ST4) and ends the state recognition operation.

When, in Step ST6, the alert controller 46 determines that the object distance X is less than or equal to the sensing distance S (object distance X ≤ sensing distance S) (Yes in Step ST6), the alert controller 46 stores the present time T, the object distance X, the visibility distance W, and the truth-value indicating whether the object distance X is less than or equal to the visibility distance W ("T" if the visibility distance W ≤ the object distance X, "F" if the visibility distance W > the object distance X) to the state record table 42A (Step ST7). Next, the alert controller 46 starts performing the alert operation and ends the state recognition operation.

The operation in Step ST6 is performed when the visibility distance W is less than or equal to the sensing distance S (visibility distance W ≤ sensing distance S) (Yes in Step ST3). In Step ST6, when the object distance X is less than or equal to the sensing distance S (object distance X ≤ sensing distance S) (Yes in Step ST6), then both the object distance X and the visibility distance W are less than or equal to the sensing distance S (object distance X ≤ sensing distance S, and visibility distance W ≤ sensing distance S). In this case, the alert controller 46 performs an alert operation to alert the driver to the object (Step ST8). When the visibility distance W is greater than the sensing distance S (sensing distance S < visibility distance W) (No in Step ST3), the driver usually visually recognizes the object, and thus the alert controller 46 does not alert the driver to the object (Step ST4). When the visibility distance W is less than or equal to the sensing distance S (visibility distance W ≤ sensing distance S) (Yes in Step ST3), the driver's attention to the front is usually reduced, and thus the alert controller 46 performs the alert operation to alert the driver to the object. In this way, by performing the state recognition operation, the vehicle control system 1 can prevent the driver from being alerted to the object when an alert is unnecessary, and alert the driver to the object when an alert is necessary.

The alert controller 46 performs the state recognition operation to calculate the object distance X and estimate the visibility distance W. The alert controller 46 performs the state recognition operation at predetermined intervals, which means that the object distance X and visibility distance W may change each time the state recognition operation is performed. When performing Step ST8 in the state recognition operation, the alert controller 46 performs the alert operation. Thus, since the state recognition operation is repeatedly performed at predetermined intervals, the alert operation is also repeatedly performed. The alert controller 46 uses the object distance X calculated in the state recognition operation and the visibility distance W estimated in the state recognition operation in the alert operation.

### Alert Operation

FIG. 5 is a flowchart of the alert operation. As shown in FIG. 5, in the alert operation, the alert controller 46 first determines whether the object distance X is greater than or equal to the visibility distance W (i.e., visibility distance W ≤ object distance X) (Step ST11). When, in Step ST11, the alert controller 46 determines that the object distance X is less than the visibility distance W (object distance X < visibility distance W) (No in Step ST11), the alert controller 46 then determines whether the object distance X is less than or equal to the alert distance D (object distance X ≤ alert distance D) (Step ST12).

When the alert controller 46 determines that the object distance X is less than or equal to the alert distance D (object distance X ≤ alert distance D) (Yes in Step ST12), the alert controller 46 displays the third-type alert on the display 34 (Step ST13) and ends the alert operation. This configuration, as shown in FIG. 3, can encourage the driver to recognize that an object is present ahead more strongly than the case where the second-type alert is provided when the object is closer to the user vehicle 3 than the alert distance D.

When determining that the object distance X is greater than the alert distance D (alert distance D < object distance X) (No in Step ST12), the alert controller 46 displays the first-type alert on the display 34 (Step ST14) and ends the alert operation. As described above with reference to FIG. 3, as the first-type alert, the alert controller 46 displays a simplified object icon 34A on the display 34. This configuration allows the driver to recognize that an object is present ahead.

When, in Step ST11, the alert controller 46 determines that the object distance X is greater than or equal to the visibility distance W (i.e., visibility distance W ≤ object distance X) (Yes in Step ST11), the alert controller 46 determines whether it has provided the second-type alert so far since detecting the situation of the visibility distance W ≤ object distance X in the state recognition operation (Step ST15). As described above, after the object is detected in the state recognition operation, the state recognition operation and the alert operation are repeatedly performed. As described later, the alert controller 46 can determine, by referring to the state record table 42A, whether it has provided the second-type alert so far since the object was first detected in the state recognition operation.

When, in Step ST15, the alert controller 46 determines that it has not provided the second-type alert since the object was first detected (No in Step ST15), the alert controller 46 displays the second-type alert on the display 34 for the alert time period Tw (Step ST16), and ends the alert operation.

In Step ST16, the alert controller 46 stores, in the state record table 42A, information (truth-value "T") indicating the provision of the second-type alert, and displays the second-type alert on the display 34 for the alert time period Tw, and subsequently displays the first-type alert on the display 34. Thus, when the state record table 42A includes the stored information ("T") indicating that the second-type alert has been provided, the alert controller 46 has provided the second-type alert since it first detected the object. When the state record table 42A does not include information ("T") indicating the provision of the second-type alert, the alert controller 46 has not provided the second-type alert since it first detected the object. In Step ST15, when the state record table 42A does not include stored information ("T") indicating that the second-type alert has been provided, the alert controller 46 determines, by referring to the state record table 42A, that the alert controller 46 has not provided the second-type alert since it first detected the object (No in Step ST15).

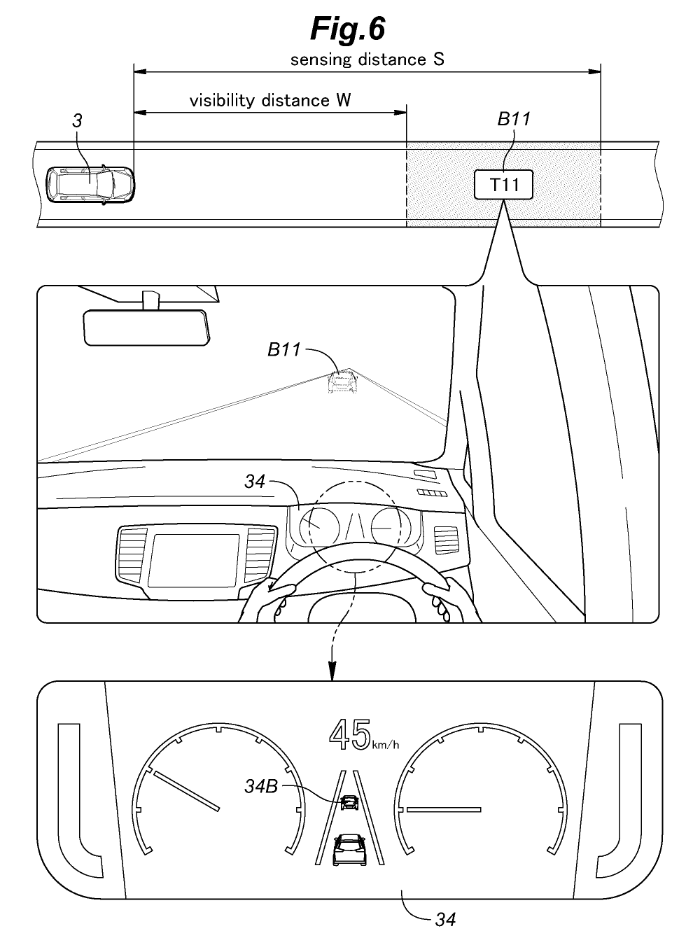

FIG. 6 shows that, when the object distance X is greater than or equal to the visibility distance W (visibility distance W ≤ object distance X), the alert controller 46 has not provided the second-type alert since the detection of the object (No in Step ST15). The time at this point (No in Step ST15) is designated as time T11. As shown in FIG. 6, under a situation at time T11, in which the object distance X is greater than or equal to the visibility distance W (visibility distance W ≤ object distance X), the driver may not visually recognize the other vehicle B11. When the second-type alert has not been provided since the alert controller 46 first detected the object, the driver is unlikely to be sufficiently aware of the other vehicle B11. Thus, in this case (No in Step ST15), the alert controller 46 displays the second-type alert on the display 34 for the alert time period Tw in Step ST16, and subsequently displays the first-type alert on the display 34. The alert time period Tw is the time interval during which the second-type alert is provided.

As described above with reference to FIG. 3, the alert controller 46 displays the icon 34B representing the object on the display 34 as the second-type alert. The second-type alert emphasizes the presence of the object compared to the first-type alert. This feature promotes the driver's recognition of the object ahead compared to when the first-type alert is performed.

Providing the second-type alert causes the driver to become more aware of the object, increasing the visibility distance W. This may cause the object distance X to become shorter than the visibility distance W (object distance X < visibility distance W). Additionally, after time point T11, another vehicle 4 may approach the user vehicle 3, causing the object distance X to become less than the visibility distance W (object distance X < visibility distance W).

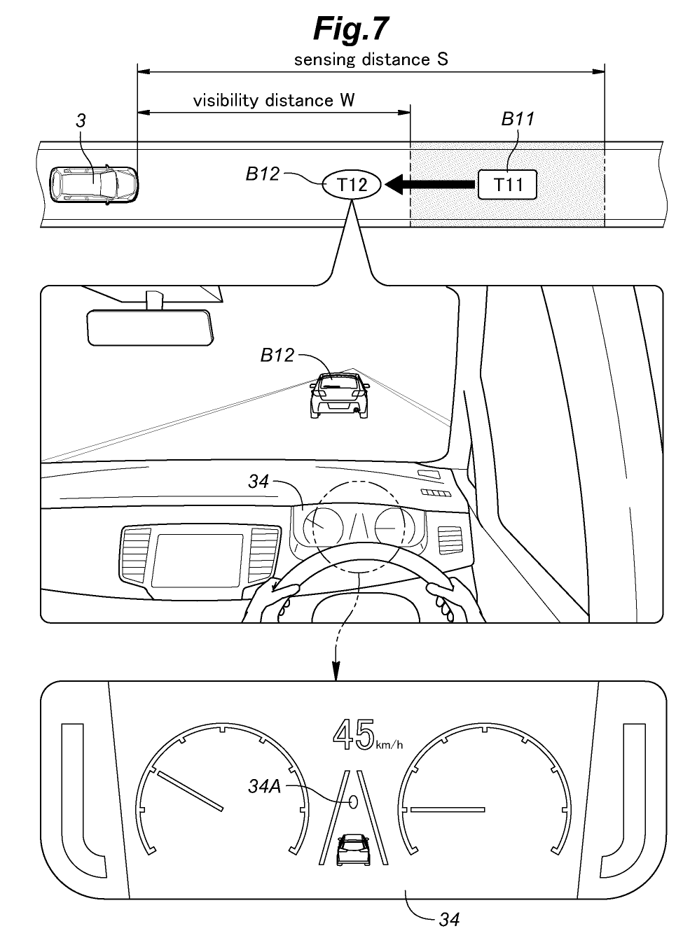

FIG. 7 shows that, when the object distance X is less than the visibility distance W (object distance X < visibility distance W), the alert controller 46 has provided the first-type alert. FIG. 7 shows the position of other vehicle B11 at time T11 and the position of the other vehicle B12 at time T12, at which, after time T11, the object distance X becomes less than the visibility distance W (object distance X < visibility distance W). FIG. 7 shows the following situations (A) to (C): (A) The visibility distance W at time T12 is substantially the same as the visibility distance W at time T11; (B) At time T12, the position of the other vehicle B12 is closer to the user vehicle 3 than at time T11; and (C) The first-type alert is being performed.

The conditions that realize the situations shown in FIG. 7 include the following Conditions 1 through 3:

Condition 1: From time T11 to T12, the visibility distance W has not changed significantly, and the object (other vehicle) has approached due to acceleration of the user vehicle 3 or deceleration of the object (other vehicle), resulting in a smaller object distance X;

Condition 2: The object distance X has not changed significantly between time T11 and time T12, and the driver is aware of the front due to an alert or similar action, causing the visibility distance W to increase; and

Condition 3: The object distance X is reduced due to acceleration of the user vehicle 3 or deceleration of the object (other vehicle) that causes the object (other vehicle) to become closer, and the visibility distance W is increased due to an alert or similar action, and at time T12, the object distance X becomes less than the visibility distance W (object distance X < visibility distance W).

When the object distance X is less than the visibility distance W (object distance X < visibility distance W), the alert controller 46 performs the operation of Step ST11, providing the first-type alert (No in Step ST11). As shown in FIG. 7, when the object distance X is less than the visibility distance W (object distance X < visibility distance W), the driver usually visually recognizes the object. Thus, when the object distance X is less than the visibility distance W (object distance X < visibility distance W), the alert controller 46 performs the operation of Step ST11 to provide the first-type alert without providing the second-type alert (No in Step ST11). This feature prevents the alert controller 46 from excessively providing an alert indicating that the object is present.

When, in Step ST15, the alert controller 46 determines that it has provided the second-type alert since first detecting the object (Yes in Step ST15), the alert controller 46 determines whether the object distance X has been less than the visibility distance W (object distance X < visibility distance W) within a time period threshold Ta (hereinafter referred to as "time threshold Ta") from the present (Step ST17). The time threshold Ta is a time interval that is long enough for the driver to remember becoming aware of the object. The time threshold Ta is, for example, 10 seconds. As described above with reference to FIG. 2, the state record table 42A stores sets of associated records including past time points T and truth-values indicating whether the visibility distance W has been less than or equal to the object distance X (value "T" if visibility distance W ≤ object distance X, value "F" if visibility distance W > object distance X). The alert controller 46 can determine, by referring to the state record table 42A, whether the object distance X has been less than the visibility distance W (object distance X < visibility distance W) within the time threshold Ta from the present.

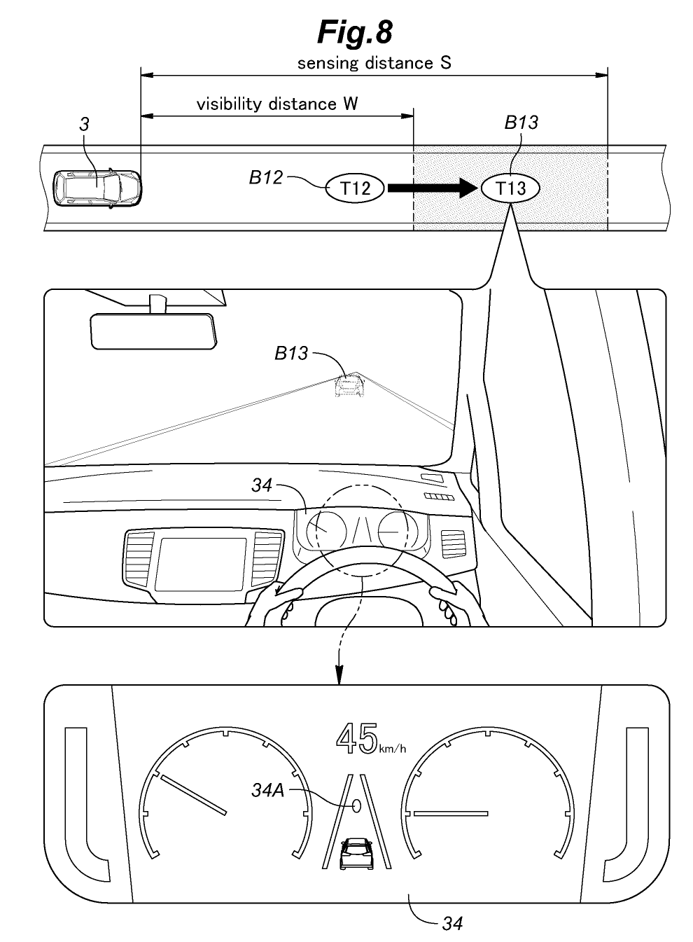

FIG. 8 shows that, when the object distance X has been less than the visibility distance W (object distance X < visibility distance W) within a time threshold Ta from the present, and the present object distance X is greater than or equal to the visibility distance W (visibility distance W ≤ object distance X) at the present (Time T13), the alert controller 46 is providing the first-type alert. Time T13 is a time when the time within the time threshold Ta has elapsed after the time T12 shown in FIG. 7. At time T12, the object distance X is less than the visibility distance W (object distance X < visibility distance W). At time T12, the vehicle B12 moves frontward (or the visibility distance W at time T13 becomes shorter than the visibility distance W at time T12), and at time T13, the vehicle B13 has an object distance X that is greater than or equal to the visibility distance W (visibility distance W ≤ object distance X).

Therefore, time T13 is a time at which the object distance X was less than the visibility distance W (object distance X < visibility distance W) within the time threshold Ta from the present (Yes in Step ST17). As shown in FIG. 8, at time T12, the object distance X is less than the visibility distance W (object distance X < visibility distance W). Therefore, at time T12, the driver usually visually recognizes the object. As time T13 is within the time threshold Ta from time T12, at time T13, the driver recognizes the object that was recognized at time T12.

When, in Step ST17, the alert controller 46 determines that the object distance X has been less than the visibility distance W (object distance X < visibility distance W) within the time threshold Ta from the present (Yes in Step ST17), the driver is usually aware of the object at the present. Therefore, the alert controller 46 displays (or continues to display) the first-type alert on the display 34 (Step ST14), and ends the alert operation. This feature prevents the alert controller 46 from excessively providing an alert indicating that the object is present compared to when providing the second-type alert.

When, in Step ST17, the alert controller 46 determines that the object distance X has not become less than the visibility distance W (object distance X < visibility distance W) within a time threshold Ta from the present (No in Step ST17), the alert controller 46 determines whether the relative speed of the object with respect to the user vehicle 3 is negative (relative speed < 0) (Step ST18). When the relative speed of the object with respect to the user vehicle 3 is negative (relative speed < 0), the object is becoming closer to the user vehicle 3.

As described above with reference to FIG. 2, the state record table 42A stores sets of associated records including past time points T and object distances X. By referring to the state record table 42A, the alert controller 46 can calculate the relative speed of the object with respect to the user vehicle 3. Thus, by using the state record table 42A, the alert controller 46 can determine whether the relative speed of the object with respect to the user vehicle 3 is negative (relative speed < 0). Furthermore, in Step ST18, the alert controller 46 may detect the current relative speed of the object with respect to the user vehicle 3 based on information about the surroundings of the user vehicle 3 (user vehicle's surrounding information) acquired by the external sensor 11.

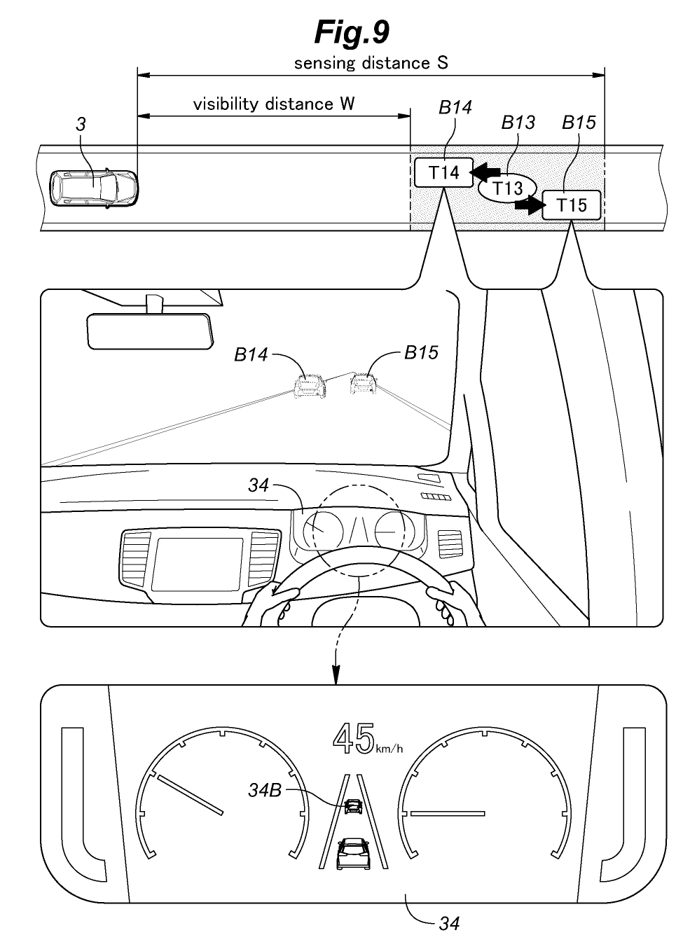

FIG. 9 shows that, when the object distance X is continuously greater than or equal to the visibility distance W (visibility distance W ≤ object distance X) for a certain time, the alert controller 46 is providing the second-type alert. Time T14 and time T15 are after time T13. At time T14, the relative speed of the other vehicle B14 with respect to the user vehicle 3 is negative (relative speed < 0). Time T15 is the time after at least a time period threshold Tb (hereinafter referred to as "time threshold Tb") has elapsed since time T13. The time threshold Tb is greater than the time threshold Ta (time threshold Tb > time threshold Ta).

When, in Step ST18, the alert controller 46 determines that the relative speed of the object with respect to the user vehicle 3 is negative (relative speed < 0) (Yes in Step ST18), the alert controller 46 displays the second-type alert on the display 34 for the alert time period Tw (Step ST16), and then ends the alert operation. When the alert controller 46 in Step ST18 determines that the relative speed of the object with respect to the user vehicle 3 is negative (relative speed < 0) (Yes in Step ST18), as shown in FIG. 9, the object distance X is greater than or equal to the visibility distance W (visibility distance W ≤ object distance X) and thus the driver does not recognize the other vehicle B14, and the other vehicle B14 is approaching the user vehicle 3. Thus, the alert controller 46 provides the second-type alert, causing the driver to recognize the other vehicle B14. When, in the operation of Step ST18, the alert controller 46 determines that the relative speed of the object with respect to the user vehicle 3 is negative (relative speed < 0) (Yes in Step ST18) while providing the first-type alert, the alert controller 46 changes the type of alert displayed on the display 34 (notifier) from the first-type alert to the second-type alert.

When, in Step ST18, the alert controller 46 determines that the relative speed of the object with respect to the user vehicle 3 is not negative (relative speed ≥ 0) (No in Step ST18), the alert controller 46 determines whether the object distance X has continuously been greater than or equal to the visibility distance W (visibility distance W ≤ object distance X) for the time threshold Tb or longer (Step ST19).

As described above with reference to FIG. 8, at time T13 (when determined as Yes in Step ST17), the driver usually recognizes the other vehicle 4. Time T15 is a time at least the time threshold Tb after time T13. At time T15, the object distance X has continuously been greater than or equal to the visibility distance W (visibility distance W ≤ object distance X) for the time threshold Tb or longer (Step ST19). When the object distance X has continuously been greater than or equal to the visibility distance W (visibility distance W ≤ object distance X) for the time threshold Tb or longer, the driver has not seen the object for the time threshold Tb or longer, and is unlikely to recognize that the object is present.

When, in Step ST19, the alert controller 46 determines that the object distance X has continuously been greater than or equal to the visibility distance W (visibility distance W ≤ object distance X) for the time threshold Tb or longer (Yes in Step ST19), the alert controller 46 displays the second-type alert on the display 34 for the alert time period Tw (Step ST16), and ends the alert operation. When the alert controller 46 determines that the object distance X is currently and has continuously been greater than or equal to the visibility distance W (visibility distance W ≤ object distance X) for the time threshold Tb or longer (Yes in Step ST19) while displaying the first-type alert on the display 34 (notifier), the alert controller 46 changes the type of alert displayed on the display 34 (notifier) from the first-type alert to the second-type alert.

When, in Step ST19, the alert controller 46 determines that the object distance X has not been continuously greater than or equal to the visibility distance W (visibility distance W ≤ object distance X) for the time threshold Tb or longer (No in Step ST19), the alert controller 46 ends the alert operation without changing the type of alert displayed on the display 34 (Step ST20). In some cases, the order of Steps ST17 to ST19 may be changed.

### Effect of the Invention

The effect achieved by the vehicle control system 1 will be described.

When the object distance X is less than or equal to the sensing distance S (object distance X ≤ sensing distance S) and also greater than or equal to the visibility distance W (visibility distance W ≤ object distance X), the alert controller 46 can display the second-type alert, which is emphasized, on the display 34 of the HMI 13 (Steps ST15 and ST16 in FIG. 5). Thus, when the object distance X is less than or equal to the sensing distance S (object distance X ≤ sensing distance S), which means that the driver desirably recognizes the object, and the object distance X is greater than or equal to the visibility distance W (visibility distance W ≤ object distance X), which means that the driver is unlikely to visually recognize the object, the vehicle control system 1 displays the second-type alert on the display 34 of the HMI 13. This configuration allows the vehicle control system 1 to properly alert the driver, whose visibility distance W has become shorter than normal, that the object is approaching the vehicle 3.

When the state in which the object distance X is greater than or equal to the visibility distance W (object distance X ≥ visibility distance W) changes to a state in which the object distance X is less than the visibility distance W (object distance X < visibility distance W), the alert controller 46 displays the first-type alert on the display 34 of the HMI 13 (Steps ST11 and ST14 in FIG. 5). Thus, when the state in which the object distance X is greater than or equal to the visibility distance W (object distance X ≥ visibility distance W), which means that the driver is presumed to be incapable of visually recognizing the object, changes to the state in which the object distance X is less than the visibility distance W (object distance X < visibility distance W), which means that the driver is presumed to be capable of visually recognizing the object, the alert controller 46 provides the first-type alert instead of the second-type alert. This feature prevents, when the object distance X is less than the visibility distance W (object distance X < visibility distance W), the alert controller 46 from excessively providing an alert indicating that the object is present.

When the state in which the object distance X is less than the visibility distance W (object distance X < visibility distance W) changes to the state in which the object distance X is greater than or equal to the visibility distance W (visibility distance W ≤ object distance X), the alert controller 46 provides the first-type alert (Steps ST17 and ST14 in FIG. 5). Thus, when the object distance X is greater than or equal to visibility distance W (visibility distance W ≤ object distance X), which means that the driver is presumed not to be capable of easily visually recognizing the object, but the driver recognizes the object (remembered its presence) because the object distance X was previously less than the visibility distance W (object distance X < visibility distance W), the alert controller 46 provides the first-type alert that is less emphasized than the second-type alert. This feature prevents the alert controller 46 from excessively providing an alert indicating that the object is present.

When the object distance X is less than or equal to the sensing distance S (object distance X ≤ sensing distance S) and is greater than or equal to the visibility distance W (visibility distance W ≤ object distance X), the alert controller 46 displays the second-type alert on the HMI 13 (notifier) for the alert time period Tw (Steps ST15, ST18, ST19, and ST16 in FIG. 5). This configuration, in which after providing the second-type alert for the alert time period Tw, the alert controller 46 changes the type of alert from the second-type alert to the first-type alert, prevents the alert controller 46 from providing the second-type alert for a long period. This feature prevents the alert controller 46 from excessively providing an alert indicating that the object is present.

When the object distance X is greater than or equal to the visibility distance W (visibility distance W ≤ object distance X), the alert controller 46 is providing the first-type alert displayed on the HMI 13 (notifier), and the relative speed of the object with respect to the vehicle 3 becomes negative, the alert controller 46 changes the type of alert displayed on the HMI 13 (notifier) from the first-type alert to the second-type alert (Steps ST18 and ST16 in FIG. 5). When the driver is presumed to be incapable of visually recognizing the object and the object is approaching the user vehicle 3, which means that the driver needs to be alerted that the object is approaching, the configuration can properly encourage the driver to recognize the approaching object.

When the object distance X has continuously been greater than or equal to the visibility distance W (object distance X ≥ visibility distance W) for the time threshold Tb or longer, the alert controller 46 changes the type of alert displayed on the HMI 13 (notifier) from the first-type alert to the second-type alert (Steps ST19 and ST16 in FIG. 5). Thus, when the object distance X has continuously been greater than or equal to the visibility distance W (object distance X ≥ visibility distance W), which means that the driver is unlikely to recognize the object, for the time threshold Tb or longer, the alert controller 46 provides the second-type alert. As a result, when the relative position between the user vehicle 3 and the object has not changed significantly for a predetermined time (time threshold Tb) or longer and the driver is unlikely to recognize the object (not remember the presence of the object), this configuration allows the vehicle control system 1 to properly alert the driver to the object.

When the object distance X is less than or equal to the alert distance D (object distance X ≤ alert distance D), the alert controller 46 provides the third-type alert displayed on the HMI 13 (notifier), which is more emphasized than the first-type alert (Steps ST12 and ST13 in FIG. 5). Thus, when the object distance X is less than or equal to the alert distance D (object distance X ≤ alert distance D), which means that the driver's recognition of the approach of the object becomes more important, the system provides the third-type alert that is more emphasized than the first-type alert. As a result, when the object distance X is less than or equal to the alert distance D (object distance X ≤ alert distance D), this configuration allows the vehicle control system 1 to properly alert the driver to the object.

The alert controller 46 calculates a distance between the vehicle 3 and an object present in the current lane of the vehicle 3 as the object distance X based on a detection result from the external sensor 11 (surrounding information acquirer). With this configuration, the alert controller 46 can properly calculate the object distance X between the vehicle and the object.

When the vehicle 3 plans to change its path, the alert controller 46 calculates a distance between the vehicle 3 and the object present in a target lane on which the vehicle intends to travel, based on the detection result from the external sensor 11 (surrounding information acquirer). With this configuration, when the vehicle 3 plans to change its path, the alert controller 46 can properly calculate the object distance X between the vehicle and the object.

The vehicle control system 1 includes the driver sensor 10 (driver information acquirer), and the alert controller 46 estimates the visibility distance W based on the detection result from the driver sensor 10 (driver information acquirer). With this configuration, the alert controller 46 can properly estimate the visibility distance W.

The alert controller 46 in the vehicle 3 estimates the visibility distance based on at least one of a continuous driving time of the driver, an amount of the driver's vehicle control, a driving assistance time during which the driving assist controller provides a driving assistance to the driver, and an amount of the vehicle control by the driving assist controller. This configuration allows the vehicle control system 1 to estimate the visibility distance W without using a sensor for detecting a driver's condition.

The above embodiments of the present invention may be described as follows.

In some embodiments, a vehicle control system 1 comprises: an external sensor 11 (surrounding information acquirer) for detecting information on an object near a vehicle 3; an HMI 13 (notifier) for alerting a driver in the vehicle 3; and an alert controller 46 for controlling the HMI 13 such that the HMI 13 (notifier) alerts the driver based on a detection result from the external sensor 11 (surrounding information acquirer), wherein the external sensor 11 (surrounding information acquirer) detects information on an object ahead at a distance that is less than or equal to a sensing distance S in a traveling direction of the vehicle 3, wherein the alert controller 46 is configured to: estimate, at predetermined intervals, a visibility distance W at which the driver of the vehicle 3 can visually recognize the object; and calculate an object distance between the object and the vehicle 3 based on the detection result from the external sensor 11 (surrounding information acquirer), wherein, when the object distance X is less than or equal to the sensing distance S (object distance X ≤ sensing distance S) and less than the visibility distance W (object distance X < visibility distance W), the alert controller causes the HMI 13 (notifier) to provide a first-type alert, and wherein, when the object distance X is less than or equal to the sensing distance (object distance X ≤ sensing distance S) and greater than or equal to the visibility distance (visibility distance W ≤ object distance X), the alert controller causes the HMI 13 (notifier) to provide a second-type alert that is more emphasized than the first-type alert.

In this configuration, when the object distance X is less than or equal to the sensing distance S (object distance X ≤ sensing distance S), which means that the driver desirably recognizes the object, and the object distance X is greater than or equal to the visibility distance W (visibility distance W ≤ object distance X), which means that the driver is unlikely to visually recognize the object, the vehicle control system 1 displays the second-type alert on the display 34 of the HMI 13. This allows the vehicle control system 1 to properly alert the driver, whose visibility distance W has become shorter than normal, that the object is approaching the vehicle 3.

In some embodiments, when the object distance X is less than or equal to the sensing distance S (object distance X ≤ sensing distance S) and the object distance X changes from being greater than or equal to the visibility distance W (visibility distance W ≤ object distance X) to being less than the visibility distance W (object distance X < visibility distance W), the alert controller 46 causes the HMI 13 (notifier) to provide the first-type alert (Steps ST11 and ST14 in FIG. 5).

In this configuration, when the state in which the object distance X is greater than or equal to the visibility distance W (visibility distance W ≤ object distance X), which means that the driver is presumed not to be capable of visually recognizing the object, changes to the state in which the object distance X is less than the visibility distance W (object distance X < visibility distance W), which means that the driver is presumed to be capable of visually recognizing the object, the alert controller 46 provides the first-type alert instead of the second-type alert. This feature prevents, when the object distance X is less than the visibility distance W (object distance X < visibility distance W), the alert controller 46 from excessively providing an alert indicating that the object is present.

When the object distance X is less than or equal to the sensing distance S (object distance X ≤ sensing distance S) and the object distance changes from being less than the visibility distance (object distance X < visibility distance W) to being greater than or equal to the visibility distance (object distance X ≥ visibility distance W), the alert controller 46 provides the first-type alert (Steps ST17 and ST14 in FIG. 5).

In this configuration, when the object distance changes from being less than the visibility distance (object distance X < visibility distance W), which means that the driver is presumed to be capable of visually recognizing the object easily, to being greater than or equal to the visibility distance (visibility distance W ≤ object distance X), which means that the driver is presumed to be incapable of visually recognizing the object easily, the alert controller 46 provides the first-type alert that is less emphasized than the second-type alert. This feature prevents the alert controller 46 from excessively providing an alert indicating that the object is present.

In some embodiments, when the object distance X is less than or equal to the sensing distance S (object distance X ≤ sensing distance S) and is greater than or equal to the visibility distance W (visibility distance W ≤ object distance X), and the alert controller 46 has displayed the second-type alert on the HMI 13 (notifier) for the alert time period Tw, the alert controller 46 changes a type of alert to be provided by the HMI 13 (notifier) from the second-type alert to the first-type alert (Step ST16 in FIG. 5).

This configuration, in which, after providing the second-type alert for the alert time period Tw, the alert controller 46 changes the type of alert from the second-type alert to the first-type alert, prevents the alert controller 46 from providing the second-type alert for a long period. This feature prevents the alert controller 46 from excessively providing an alert indicating that the object is present.

In some embodiments, when the object distance X is less than or equal to the sensing distance S (object distance X ≤ sensing distance S) and is greater than or equal to the visibility distance W (visibility distance W ≤ object distance X), the HMI 13 (notifier) is providing the first-type alert, and the relative speed of the object with respect to the vehicle 3 becomes negative, the alert controller changes a type of alert to be provided by the HMI 13 (notifier) from the first-type alert to the second-type alert (Steps ST18 and ST16 in FIG. 5).

In this configuration, when the driver is presumed to be incapable of visually recognizing the object and the object is approaching the user vehicle 3, which means that the driver needs to be alerted that the object is approaching, the configuration can properly encourage the driver to recognize the approaching object.

In some embodiments, when the object distance X is less than or equal to the sensing distance S (object distance X ≤ sensing distance S) and greater than or equal to the visibility distance W (object distance X ≥ visibility distance W), HMI 13 (notifier) is providing the first-type alert, and the object distance has continuously been greater than or equal to the visibility distance for a time threshold Tb, the alert controller 46 changes a type of alert to be provided by the HMI 13 (notifier) from the first-type alert to the second-type alert.

In this configuration, when the object distance X has continuously been greater than or equal to the visibility distance W (object distance X ≥ visibility distance W), which means that the driver is unlikely to recognize the object, for the time threshold Tb or longer, the alert controller 46 provides the second-type alert. This configuration allows the vehicle control system 1 to properly alert the driver to the object when the driver is unlikely to recognize the object.

In some embodiments, when the object distance X is less than or equal to the alert distance D (object distance X ≤ alert distance D < visibility distance W), the alert controller 46 causes the HMI 13 (notifier) to provide a third-type alert which is more emphasized than the first-type alert (Steps ST12 and ST13 in FIG. 5).

In this configuration, when the object distance X is less than or equal to the alert distance D (object distance X ≤ alert distance D), which means that the driver's recognition of the approach of the object becomes more important, the system provides the third-type alert that is more emphasized than the first-type alert. Thus, when the object distance X is less than or equal to the alert distance D (object distance X ≤ alert distance D), this configuration allows the vehicle control system 1 to properly alert the driver to the object.

In some embodiments, the alert controller 46 calculates a distance between the vehicle 3 and an object present in the current lane of the vehicle 3 as the object distance X based on a detection result from the external sensor 11 (surrounding information acquirer).

With this configuration, the alert controller 46 can properly calculate the object distance X between the vehicle and the object.

In some embodiments, when the vehicle 3 plans to change its path, the alert controller 46 calculates a distance between the vehicle 3 and the object present in a target lane on which the vehicle 3 intends to travel, based on the detection result from the external sensor 11 (surrounding information acquirer).

With this configuration, when the vehicle 3 plans to change its path, the alert controller 46 can properly calculate the object distance X between the vehicle and the object.

In some embodiments, the vehicle control system 1 includes a driver sensor 10 (driver information acquirer), and the alert controller 46 estimates the visibility distance W based on a detection result from the driver sensor 10 (driver information acquirer).

With this configuration, the alert controller 46 can properly estimate the visibility distance W.

In some embodiments, the vehicle control system 1 includes a driving assist controller 45 for assisting the driver, and the alert controller 46 in the vehicle 3 estimates the visibility distance based on at least one of a continuous driving time of the driver, an amount of the driver's vehicle control, a driving assistance time during which the driving assist controller provides a driving assistance to the driver, and an amount of the vehicle control by the driving assist controller.

This configuration allows the vehicle control system 1 to estimate the visibility distance W without using a sensor for detecting a driver's condition.

The present invention has been described in terms of specific embodiments. However, it is not limited to such embodiments, and can be embodied with various modifications.

1. A vehicle control system comprising:
a surrounding information acquirer for detecting information on an object near a vehicle;
a notifier for alerting a driver in the vehicle; and
an alert controller for controlling the notifier such that the notifier alerts the driver based on a detection result from the surrounding information acquirer,
wherein the surrounding information acquirer detects information on an object ahead at a distance that is less than or equal to a sensing distance in a traveling direction of the vehicle,
wherein the alert controller is configured to:
estimate, at predetermined intervals, a visibility distance at which the driver of the vehicle can visually recognize the object; and
calculate an object distance between the object and the vehicle based on the detection result from the surrounding information acquirer,
wherein, when the object distance is less than or equal to the sensing distance and less than the visibility distance, the alert controller causes the notifier to provide a first-type alert, and
wherein, when the object distance is less than or equal to the sensing distance and greater than or equal to the visibility distance, the alert controller causes the notifier to provide a second-type alert that is more emphasized than the first-type alert.

2. The vehicle control system as claimed in claim 1, wherein, when the object distance is less than or equal to the sensing distance and the object distance changes from being greater than or equal to the visibility distance to being less than the visibility distance, the alert controller causes the notifier to provide the first-type alert.

3. The vehicle control system as claimed in claim 1, wherein, when the object distance is less than or equal to the sensing distance and the object distance changes from being less than the visibility distance to being greater than or equal to the visibility distance, the alert controller causes the notifier to provide the first-type alert.

4. The vehicle control system as claimed in claim 1, wherein, when the object distance is less than or equal to the sensing distance and is greater than or equal to the visibility distance, and the notifier has been providing the second-type alert for an alert time period, the alert controller changes a type of alert to be provided by the notifier from the second-type alert to the first-type alert.

5. The vehicle control system as claimed in claim 3, wherein, when the object distance is less than or equal to the sensing distance and is greater than or equal to the visibility distance, the notifier is providing the first-type alert, and a relative speed of the object with respect to the vehicle becomes negative, the alert controller changes a type of alert to be provided by the notifier from the first-type alert to the second-type alert.

6. The vehicle control system as claimed in claim 3, wherein, when the object distance is less than or equal to the sensing distance and is greater than or equal to the visibility distance, the notifier is providing the first-type alert, and the object distance has continuously been greater than or equal to the visibility distance for a time period threshold, the alert controller changes a type of alert to be provided by the notifier from the first-type alert to the second-type alert.

7. The vehicle control system as claimed in claim 1, wherein, when the object distance is less than or equal to an alert distance which is less than the visibility distance, the alert controller causes the notifier to provide a third-type alert which is more emphasized than the first-type alert.

8. The vehicle control system as claimed in claim 1, wherein the alert controller calculates a distance between the vehicle and the object present in a current lane on which the vehicle is currently traveling as the object distance, based on the detection result from the surrounding information acquirer.

9. The vehicle control system as claimed in claim 1, wherein, when the vehicle plans to change its path, the alert controller calculates a distance between the vehicle and the object present in a target lane on which the vehicle intends to travel, based on the detection result from the surrounding information acquirer.

10. The vehicle control system as claimed in claim 1, further comprising a driver information acquirer for detecting information on a state of the driver of the vehicle,
wherein the alert controller estimates the visibility distance based on a detection result from the driver information acquirer.

11. The vehicle control system as claimed in claim 1, wherein the vehicle comprises a driving assist controller for assisting the driver, and
wherein the alert controller estimates the visibility distance based on at least one of a continuous driving time of the driver, an amount of the driver's vehicle control, a driving assistance time during which the driving assist controller provides a driving assistance to the driver, and an amount of the vehicle control by the driving assist controller.
